(19) United States
(12) Patent Application Publication
(10) Pub. No.: US 2018/0213289 A1
(43) Pub. Date: Jul. 26, 2018

(54) METHOD OF AUTHORIZING VIDEO SCENE AND METADATA

(71) Applicant: Electronics and Telecommunications Research Institute, Daejeon (KR)

(72) Inventors: Sang Yun LEE, Daejeon (KR); Sun Joong KIM, Sejong-si (KR); Won Joo PARK, Daejeon (KR); Jeong Woo SON, Daejeon (KR)

(73) Assignee: Electronics and Telecommunications Research Institute, Daejeon (KR)

(21) Appl. No.: 15/838,698

(22) Filed: Dec. 12, 2017

(30) Foreign Application Priority Data
Jan. 26, 2017 (KR) 10-2017-0012414

(51) Int. Cl. H04N 21/472; H04N 21/235; H04N 21/231; G06F 3/0486

(52) U.S. Cl. CPC H04N 21/47205; G06F 3/0486; H04N 21/23109; H04N 21/2353

(57) ABSTRACT

Provided is a method of authorizing a video scene and metadata for providing a GUI screen provided to a user for authorizing the video scene and the metadata. The method includes generating a GUI screen configuration for an input of data including a video, sound, subtitles, and a script, generating a GUI screen configuration for extracting and editing shots from the data, generating a GUI screen configuration for generating and editing scenes, based on the shots, generating a GUI screen configuration for automatically generating and editing metadata of the scenes, and generating a GUI screen configuration for storing the scenes and the metadata in a database.

### CROSS-REFERENCE TO RELATED APPLICATIONS

This application claims priority under 35 U.S.C. § 119 to Korean Patent Application No. 10-2017-0012414, filed on Jan. 26, 2017, the disclosure of which is incorporated herein by reference in its entirety.

### TECHNICAL FIELD

The present invention relates to technology for providing a graphical user interface (GUI) screen for generating and editing a scene and metadata corresponding to the scene from a video.

### BACKGROUND

Portal sites such as YouTube, Naver, etc. and content providers such as broadcasting companies, etc. provide users with various pieces of video content such as dramas, movies, etc. by using a downloading service method, a streaming service method, a video on demand (VOD) service method, or the like. Here, the VOD service method is a service method which allows a user to select and watch only a partial scene of video content.

Generally, users show high interest in an appearing actor or a story of video content, but have very high interest in propos possessed by or dress worn on an actor appearing in a specific scene.

Therefore, interest in propos possessed by or dress worn on an actor appearing in a specific scene leads to the desires of users for purchase, and consequently, in terms of business operators for selling relevant products, it is required to develop technology for providing users with information about propos possessed by or dress worn on an actor appearing in a specific scene.

Various conventional technologies for providing a specific scene of a video and information associated with the specific scene are being researched, but have the following problems.

First, in the conventional technologies, in a process of generating a scene from a video, a specific scene is generated by a manual operation, but there is no device which automatically and mechanically generates a scene.

Second, the conventional technologies do not automatically generate information (or metadata) associated with a scene.

Third, in a case of correcting a scene, since information (metadata) corresponding to the scene should be re-generated (updated), the conventional technologies do not automatically re-generate the information.

As described above, the conventional technologies cannot automatically perform a series of processes of dividing a video into a plurality of scenes and generating and editing scene-based metadata, and for this reason, due to a manual operation, inconvenience is caused, and much processing time is needed.

### SUMMARY

Accordingly, the present invention provides a method of automatically generating a scene and metadata corresponding to the scene from a video.

The present invention also provides an authorization method which removes an undesired portion of an automatically generated shot and scene to edit an output product so as to save a storage capacity.

The objects of the present invention are not limited to the aforesaid, but other objects not described herein will be clearly understood by those skilled in the art from descriptions below.

In one general aspect, a method of authorizing a video scene and metadata for providing a GUI screen provided to a user for authorizing the video scene and the metadata in an electronic device including a computer processor includes generating, by the computer processor, a GUI screen configuration for an input of data including a video, sound, subtitles, and a script, generating, by the computer processor, a GUI screen configuration for extracting and editing shots from the data, generating, by the computer processor, a GUI screen configuration for generating and editing scenes, based on the shots, generating, by the computer processor, a GUI screen configuration for automatically generating and editing metadata of the scenes, and generating, by the computer processor, a GUI screen configuration for storing the scenes and the metadata in a database.

Other features and aspects will be apparent from the following detailed description, the drawings, and the claims.

### BRIEF DESCRIPTION OF THE DRAWINGS

FIG. 1 is a block diagram of an authorization apparatus according to an embodiment of the present invention.

FIG. 2 is a diagram illustrating a configuration of a GUI screen provided in an operation processing process performed by a data input unit illustrated in FIG. 1.

FIG. 3 is a diagram illustrating a configuration of a GUI screen provided in an operation processing process performed by a shot extracting and editing unit illustrated in FIG. 1.

FIG. 4 is a diagram illustrating a configuration of a GUI screen provided in an operation processing process performed by a scene generating and editing unit illustrated in FIG. 1.

FIG. 5 is a diagram illustrating a configuration of a GUI screen provided in an operation processing process performed by a metadata generating and editing unit illustrated in FIG. 1.

FIG. 6 is a diagram illustrating a configuration of a GUI screen provided in an operation processing process performed by a data storing unit illustrated in FIG. 1.

FIG. 7 is a block diagram of an electronic device including the authorization apparatus illustrated in FIG. 1.

FIG. 8 is a flowchart of a method of authorizing video scene and metadata according to an embodiment of the present invention.

### DETAILED DESCRIPTION OF EMBODIMENTS

Hereinafter, embodiments of the present invention will be described in detail with reference to the accompanying drawings. Terms used herein are terms that have been selected in consideration of functions in embodiments, and the meanings of the terms may be altered according to the intent of a user or operator, or conventional practice. Therefore, the meanings of terms used in the below-described embodiments confirm to definitions when defined specifically in the specification, but when there is no detailed definition, the terms should be construed as meanings known to those skilled in the art.

The invention may have diverse modified embodiments, and thus, example embodiments are illustrated in the drawings and are described in the detailed description of the invention. However, this does not limit the invention within specific embodiments and it should be understood that the invention covers all the modifications, equivalents, and replacements within the idea and technical scope of the invention. Like numbers refer to like elements throughout the description of the figures.

It will be understood that, although the terms first, second, A, B, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention provides an authorization apparatus for automatically performing a series of processes of dividing a video into a plurality of scenes and generating and editing metadata corresponding to each of the plurality of scenes.

The authorization apparatus may be equipped in all electronic devices which include a communication function of receiving a video from a video provider (for example, a broadcasting station server or the like) over a communication network in a downloading method, a streaming method, or the like, and reproduce the video.

The electronic devices may each include, for example, a controller configured with a microcomputer, a central processing unit (CPU), or the like, a storage unit configured with a non-volatile storage medium, storing digital data, such as hard disk drive (HDD), flash memory, or the like, a CD-ROM or DVD-ROM driver, a display unit, an audio unit for outputting a game sound, an input unit configured with a keyboard, a keypad, a mouse, a joystick, a microphone, or the like, and a wired/wireless communicator accessing a video provider over a communication network. Here, the communication network may be configured irrespective of a communication scheme such as wired and wireless and may be configured with various communication networks such as a personal area network (PAN), a local area network (LAN), a metropolitan area network (MAN), a wide area network (WAN), an Internet network, a mobile communication network, and a heterogeneous communication network configured by a combination thereof.

Examples of the electronic devices may include notebook personal computers (PCs), desktop PCs, cellular phones, personal communication services (PCS) phones, synchronous/asynchronous international mobile telecommunication-2000 (IMT-2000), palm PC, personal digital assistants (PDAs), smartphones, wireless application protocol phones (WAPs), play stations, etc.

Hereinafter, an authorization apparatus according to an embodiment of the present invention will be described in detail with reference to the accompanying drawings.

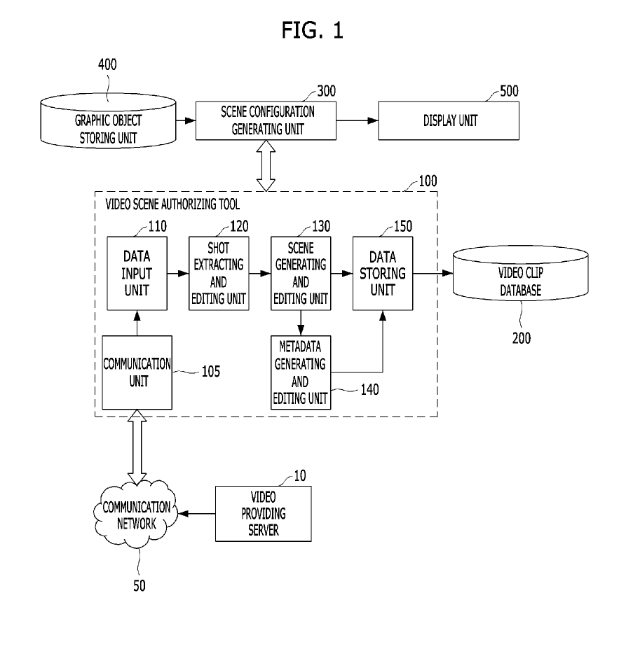

FIG. 1 is a block diagram of an authorization apparatus according to an embodiment of the present invention.

Referring to FIG. 1, the authorization apparatus according to an embodiment of the present invention may include a video scene authorizing tool 100, a video clip database 200, a scene configuration generating unit 300, a graphic object storing unit 400, and a display unit 500.

The video scene authorizing tool 100 may be an element which generates and extracts a scene and metadata from a video provided from a video providing server 10 over a communication network 50, and may be implemented with a software module or a hardware module which executes an extraction process. The video scene authorizing tool 100 implemented with the software module may be stored in a storage medium and may be loaded into a memory and executed according to a request of a computer processor. The video scene authorizing tool 100 implemented with the hardware module may be embedded into the computer processor.

The video clip database 200 may store the scene and the metadata, generated and extracted by the video scene authorizing tool 100, in a schema structure. In the present specification, the video clip database 200 may be referred to as a storage medium storing a scene and metadata. Since a database denotes a set of data in dictionary definition, the database and the storage medium may be differentiated from each other. In a case where the database and the storage medium are differentiated from each other, the video clip database 200 may be stored in the storage medium.

The screen configuration generating unit 300 may construct an operation process, performed by the video scene authorizing tool 100, as an interface screen by using various graphic objects stored in the graphic object storing unit 400 and may display the constructed interface screen on the display unit 500. The scene configuration generating unit 300 may be a software module or a hardware module executable by a computer processor. Similarly to the video scene authorizing tool 100, the scene configuration generating unit 300 implemented with the software module may be stored in a storage medium and may be loaded into a memory and executed according to a request of the computer processor, and the scene configuration generating unit 300 implemented with the hardware module may be embedded into the computer processor. In a case where the scene configuration generating unit 300 implemented with the hardware module is embedded into the computer processor, the computer processor may be a graphics processing unit (GPU).

The graphic object storing unit 400 may be a storage medium which stores various graphic objects for constructing the interface screen, and may provide a corresponding graphic object to the scene configuration generating unit 300 according to a request of the scene configuration generating unit 300. Here, the graphic objects may include various types of icons representing an operation situation, a button, an input window, a connection bar, a frame defining a display region of a specific screen, an arrow, a text including a letter and a number, a display line representing a table form, various colors, etc.

The display unit 500 may convert the interface screen provided from the scene configuration generating unit 300 into visual information and may display the interface screen as the visual information. The display unit 500 may include a display panel, such as a liquid crystal display (LCD) panel, an organic light emitting diode (OLED) panel, a touch panel, or the like, and a controller that controls the display panel.

Video Scene Authorizing Tool 100

The video scene authorizing tool 100, as illustrated in FIG. 1, may include a communication unit 105, a data input unit 110, a shot extracting and editing unit 120, a scene generating and editing unit 130, a metadata generating and editing unit 140, and a data storing unit 150.

The communication unit 105 may receive broadcasting data (or broadcasting content) including video data, audio data, a subtitles file, and a script file from the video providing server 10 over the communication network 50.

The data input unit 110 may collect, by units of frames, the broadcasting data input from the communication unit 105 and may provide the shot extracting and editing unit 130 with the collected broadcasting data by units of frames.

The shot extracting and editing unit 120 may extract a plurality of shots from the broadcasting data and may perform an editing operation on the extracted shot. Here, the shot may be the term differentiated from a scene, and in a case where a plurality of cameras photograph the same one situation at several angles, the shot may be defined as an image obtained by each of the cameras. Therefore, a plurality of shots may have semantic similarity, temporal correlation, or semantic correlation, and a set of the plurality of shots may be referred to as a scene.

The shot extracting and editing unit 120 may extract a shot sequence, based on similarity between a previous frame and a current frame which constitute the video data. For example, the similarity may be calculated based on a difference between image feature information about the previous frame and image feature information about the current frame. Here, the image feature information may include HUG, a color histogram, SIFT, a motion vector, intensity, etc. As another example, the similarity may be calculated based on a difference between sound feature information about the previous frame and sound feature information about the current frame. Here, the sound feature information may include LSTER, HZCRR, spectrum flux, etc. As another example, the similarity may be calculated based on a difference between text feature information detected from subtitles corresponding to each shot and text feature information detected from a script. Here, the text feature information may be obtained through language processing technology. Here, the language processing technology departs from the technical gist of the present invention, and thus, known technology is applied to its detailed description. As another example, the similarity may be calculated based on all of the difference of the image feature difference, the difference of the sound feature difference, and the difference of the text feature difference.

The scene generating and editing unit 130 may generate a scene, based on each of the extracted shots and may perform an editing operation on the generated scene. The scene generating and editing unit 130 may generate an initial scene, based on similarity between shots and may analyze correlation between the initial scene and another scene. The correlation between the scenes may be analyzed by an unstructured data analysis method (or unstructured data mining) which extracts information associated with a scene through an analysis of data subtitles and a script and performs unstructured data analysis on the extracted information.

The metadata generating and editing unit 140 may automatically generate metadata of each of the generated scenes and may perform an editing operation on the automatically generated metadata. Here, the metadata may be attribute data of each scene such as a scene number, a scene start time corresponding to the scene number, a scene end time corresponding to the scene number, and a headword capable of representatively expressing a scene identified by the scene number. Particularly, a scene-unit headword may be used as useful information capable of being associated with various application service systems. For example, the headword may be associated with an application service system such as a product advertising system which associates a headword of each scene with a product.

The headword may be generated by analyzing sound data and text data (for example, a subtitles file and a script file) corresponding to each scene. A method of analyzing the sound data and the text data may use sound recognition technology, language processing technology, unstructured data mining, deep-learning, machine learning, etc.

The headword may be classified into several headwords for each scene through the analysis, and each of the classified headwords may have a weight value which represents significance.

The data storing unit 150 may store the scene generated and edited by the scene configuration generating unit 300 and the metadata generated and edited by the metadata generating and editing unit 140.

The video clip database 200 may construct the scene and the metadata as a specific material structure and may store the material structure. The material structure may include, for example, a program identification (ID) for individually identifying a broadcasting program, a scene number for individually identifying each scene, a scene start time for expressing a start point of each scene, a scene end time for expressing an end point of each scene, and a headword of each scene. In this case, a value of each of the scene start time and the scene end time may be represented as a hour unit, or may be represented as a frame number. A headword attribute may include several headword values for each scene. Here, the headword attribute may further include a weight value which represents significance of each headword.

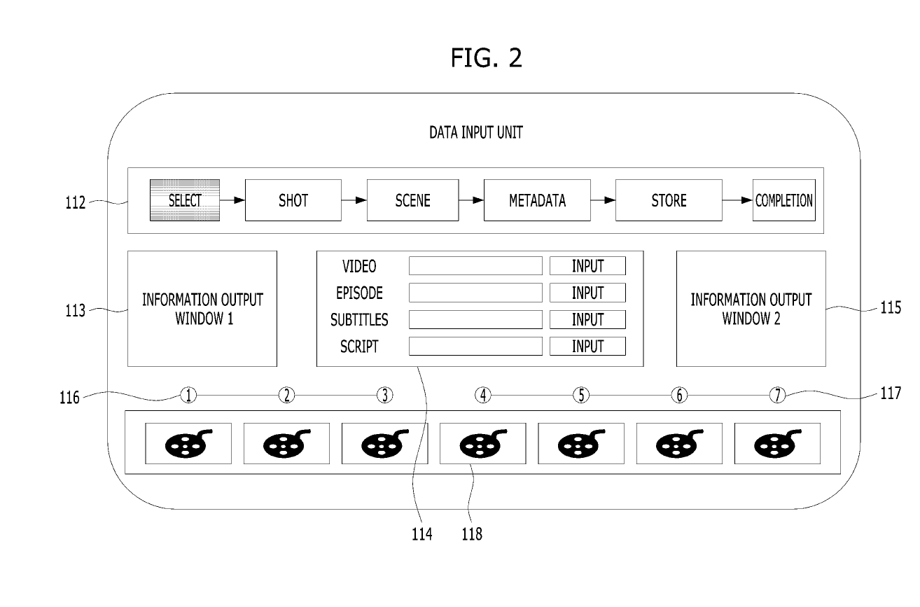

FIG. 2 is a diagram illustrating a configuration of a GUI screen provided to a user in an operation processing process performed by the data input unit illustrated in FIG. 1.

Referring to FIG. 2, a screen displayed in an operation processing process performed by the data input unit 110 may include a progress state block 112, a first information output window 113, a data input block 114, a second information output window 115, connection bar blocks 116 and 117, and an image window 118.

The progress state block 112 may include a plurality of blocks for representing a progress situation of an operation process performed by the video scene authorizing tool 100.

The progress state block 112 may include a block representing a video selection operation process, a block representing a shot generation and editing operation process, a block representing a scene generation and editing operation process, a block representing a metadata generation and editing operation process, a block representing a storage operation process, and a block representing an operation completion process. If a current operation process is an operation process of selecting a video, the video selection operation process may be activated in a specific color. When a user touches an arbitrary block of a plurality of blocks, an operation screen may be changed to an operation process corresponding to the touched block. Therefore, the progress state block 112 may provide an input function for changing (moving) to a specific operation process.

The first information output window 113 may display information about a video, subtitles, a script, and the like of selected broadcasting content.

The data input block 114 may be a block for inputting video information, episode information, subtitles information, script information, etc. and may include an input window through which video information is input, an input window through which episode is input, an input window through which subtitles are input, and an input window through which a script is input.

The second information output window 115 may display introduction information about the video scene authorizing tool 100.

The image window 118 may include a plurality of windows for respectively displaying representative key frame images of a shot or a scene. In an initial state before video data is input, there is yet no representative key frame image, and thus, the image window 118 may display a basic image.

The connection bar blocks 116 and 117 may display correlation between representative key frame images of a shot or a scene, and shots or scenes having high correlation may be displayed as continuous connection bars as illustrated in FIG. 2.

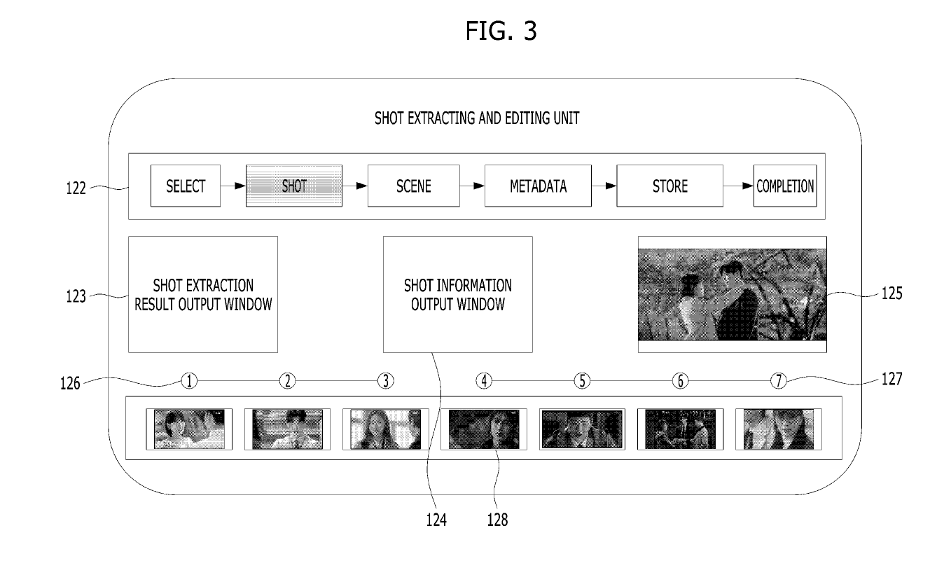

FIG. 3 is a diagram illustrating a configuration of a GUI screen provided in an operation processing process performed by the shot extracting and editing unit illustrated in FIG. 1.

Referring to FIG. 3, a screen displayed in an operation performed by the shot extracting and editing unit 120 may include a progress state block 122, a shot extraction result output window 123, a shot information output window 124, connection bar blocks 126 and 127, and an image window 128.

The progress state block 122 may display a progress situation of an operation process performed by the video scene authorizing tool 100 and may have the same function as that of the progress state block illustrated in FIG. 2. Since a current operation process is an operation of extracting a shot from a selected video, a block representing a shot extracting operation may be activated in a specific color.

The shot extraction result window 123 may display shot extraction result information including final result information or intermediate result information which is generated while a shot is being extracted from the selected video.

The shot information output window 124 may display information about the extracted shot.

The connection bar blocks 126 and 127 may display correlation between shots extracted from the video.

The image window 128 may display a representative key frame image of a shot extracted from the video. In an initial state before a shot is extracted, since there is no representative key frame image, the image window 128 may display a basic image. A representative key frame may be selected from the image window 128, and a shot including the selected key frame may be deleted by using a drag and drop function. Alternatively, a plurality of representative key frames may be simultaneously selected and may be deleted at a time.

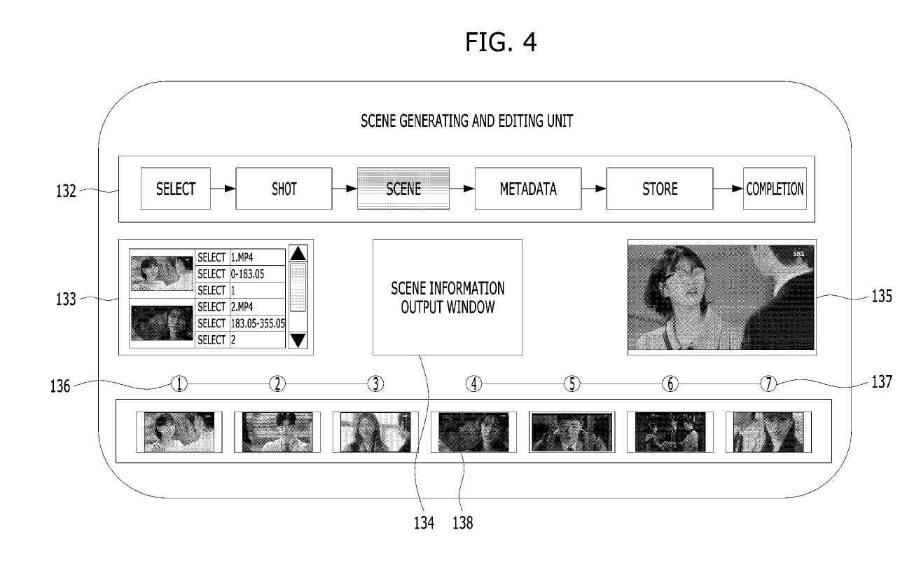

FIG. 4 is a diagram illustrating a configuration of a GUI screen provided in an operation processing process performed by the scene generating and editing unit illustrated in FIG. 1.

Referring to FIG. 4, a screen displayed in an operation performed by the scene generating and editing unit 130 may include a progress state block 132, a scene generation result output window 133, a scene information output window 134, a video reproduction window 135, connection bar blocks 136 and 137, and an image window 138.

The progress state block 132 may have the same function as that of each of the above-described progress state blocks 112 and 122. Therefore, the description of the display function of each of the progress state blocks 112 and 122 is applied to the progress state block 132.

The scene generation result output window 133 may display intermediate result information or final result information which is generated in a scene generating operation. The intermediate result information or the final result information may include, for example, a file name, a scene time, and a scene number allocated to a corresponding scene.

The scene information output window 134 may display information about a generated scene.

The video reproduction window 135 may continuously display generated scenes.

The connection bar blocks 136 and 137 may have the same function as that of each of the above-described connection bar blocks 116 and 117 or 126 and 127. Thus, the descriptions of the display functions of the connection bar blocks 116 and 117 or 126 and 127 are applied to the connection bar blocks 136 and 137.

The image window 138 may display a representative key frame image of a scene. In an initial state before a scene is generated, since there is no representative key frame image, the image window 138 may display a basic image. A representative key frame may be selected from the image window 138, and a shot including the selected key frame may be deleted by using a drag and drop function. Alternatively, a plurality of representative key frames may be simultaneously selected and may be deleted at a time.

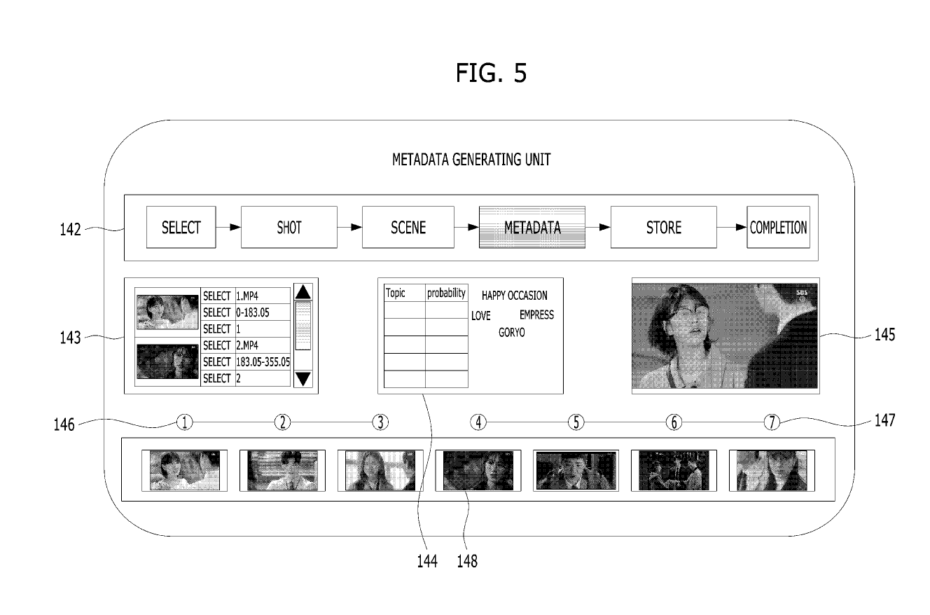

FIG. 5 is a diagram illustrating a configuration of a GUI screen provided in an operation processing process performed by the metadata generating and editing unit illustrated in FIG. 1.

Referring to FIG. 5, a screen displayed in an operation performed by the metadata generating and editing unit 140 may include a progress state block 142, a scene information output window 143, a metadata generation result output window 144, a video reproduction window 145, connection bar blocks 146 and 147, and an image window 148.

The progress state block 142 may have the same function as that of each of the above-described progress state blocks 112, 122, and 132. Therefore, the description of the display function of each of the progress state blocks 112, 122, and 132 is applied to the progress state block 142.

The scene information output window 143 may display information about a scene corresponding to metadata which is being currently generated. Here, the information about the scene may include, for example, a scene number, a scene time, etc.

The metadata generation result output window 144 may display metadata generation result information for showing or searching for an intermediate result or a final result while metadata is being generated.

The metadata generation result information may be a table which includes a topic (or a headword) associated with a corresponding scene and similarity between the corresponding scene and the topic (or the headword).

Moreover, the metadata generation result information may not be configured in a table form but may be configured so that arrangement, sizes, and colors of headwords corresponding to a topic associated with a corresponding scene are variously set, and thus, a user can easily and visually recognize headwords in descending order of correlation with a corresponding scene. For example, as illustrated in the drawing, when a selected video is a drama of which a background is Goryo dynasty and headwords of a generated scene are “Goryo”, “empress”, “happy occasion”, and “love” in descending order of correlation with a corresponding scene, the headwords may be arranged in a cochlea form, and sizes of texts may be set to be reduced in the order of highest correlation to lowest correlation.

The video reproduction window 145 may display corresponding scenes so as to be successively reproduced.

The connection bar blocks 146 and 147 may display a relationship between scenes by using a bar.

The image window 148 may display a representative key frame image of a scene. In an initial state before a scene is generated, since there is no representative key frame image, the image window 148 may display a basic image. A representative key frame may be selected from the image window 148, and a shot including the selected key frame may be deleted by using a drag and drop function. Alternatively, a plurality of representative key frames may be simultaneously selected and may be deleted at a time.

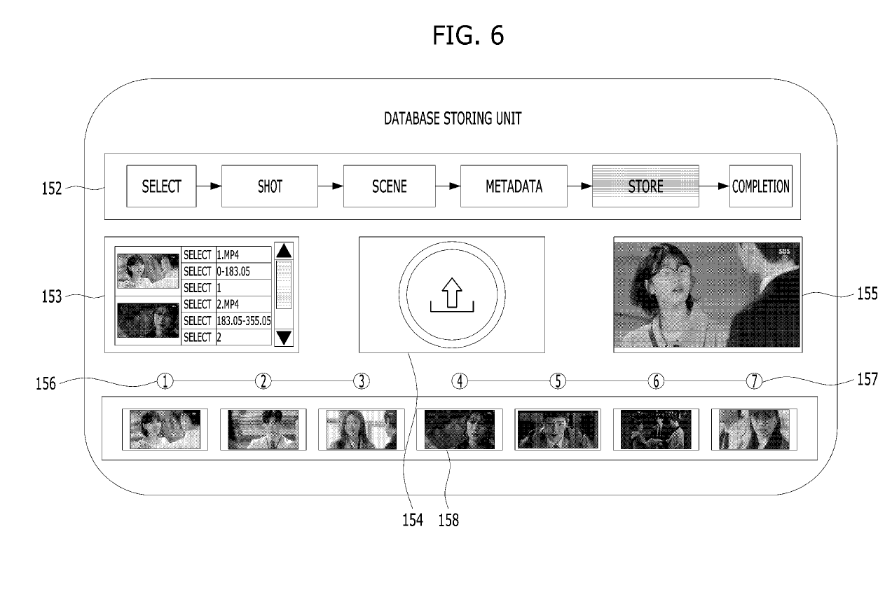

FIG. 6 is a diagram illustrating a configuration of a GUI screen provided in an operation processing process performed by the data storing unit illustrated in FIG. 1.

Referring to FIG. 6, a screen displayed in an operation performed by the data storing unit 150 may include a progress state block 152, a scene information output window 153, a state information output window 154, and a video reproduction window 155.

The progress state block 152 may have the same function as that of each of the above-described progress state blocks 112, 122, 132, and 142. Therefore, the description of the display function of each of the progress state blocks 112, 122, 132, and 142 is applied to the progress state block 152.

The scene information output window 153 may display information about a scene while storage is being performed in the video clip database 200. Here, the information about the scene may include, for example, a scene time, a scene number, etc.

The state information output window 154 may display a storage progress situation of the video clip database 200 by using various graphic objects in order for a user to recognize the storage progress situation.

The video reproduction window 155 may continuously display scenes which are being stored, so as to reproduce the scenes.

As described above, the apparatus for authorizing video scene and metadata according to an embodiment of the present invention may automatically perform a series of processes of dividing a video into a plurality of scenes and generating and editing metadata corresponding to each of the plurality of scenes, and may provide the automatic processing process through the GUI screen having easy accessibility.

Therefore, a process of extracting and generating a shot, a scene, and metadata from a video may be automatized, a shot extracting operation, a scene generating operation, and a shot extracting operation, a scene generating operation, and a metadata generating operation may be displayed on the GUI screen having easy accessibility, thereby enabling correction and editing to be conveniently performed.

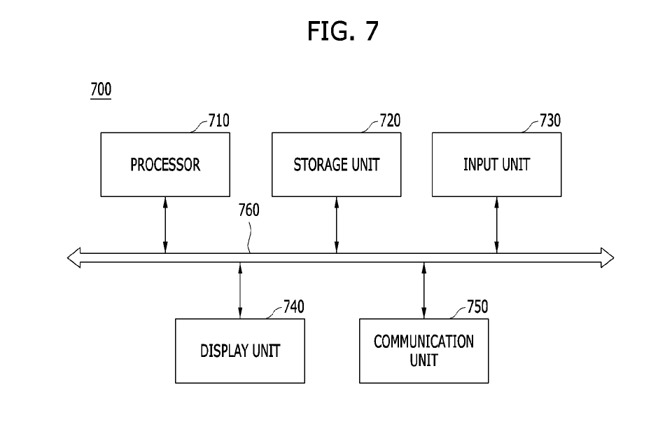

FIG. 7 is a block diagram of an electronic device including the authorization apparatus illustrated in FIG. 1.

Referring to FIG. 7, the electronic device including the authorization apparatus according to an embodiment of the present invention may include a processor 710, a storage unit 720, an input unit 730, a display unit 740, a communication unit 750, and a system bus 760.

The processor 710 may perform a process of generating a video scene and metadata corresponding to the video scene. In order to perform the process, the processor 710 may include a microcomputer or a central processing unit (CPU). Also, the processor 710 may perform a graphic process of generating a user interface (UI) screen which enables the video scene and the metadata to be edited. In order to perform the graphic process, the processor 710 may further include a graphic processor.

In order to perform the process, the processor 710 may include a plurality of hardware modules which are distinguished from one another by functions. For example, if the video scene authorizing tool 100 and the scene configuration generating unit 300 illustrated in FIG. 1 are each implemented with a hardware module, the processor 710 may include the video scene authorizing tool 100 and the scene configuration generating unit 300 which are each implemented with a hardware module.

The storage unit 720 may store a program for generating a video scene and metadata corresponding to the video scene, and moreover, may store the video scene and the metadata which are generated by the program. Also, the storage unit 720 may store an operating system (OS) for executing the program. Also, the storage unit 720 may include the graphic object storing unit 400 and the video clip database 200 illustrated in FIG. 1. To this end, the storage unit 720 may include a non-volatile storage medium, storing digital data, such as HDD, flash memory, or the like, and a volatile storage medium such as random access memory (RAM) or the like.

The input unit 730 may be an element for receiving a user input and may include a touch screen, a keyboard, a keypad, a mouse, a joystick, a microphone, and/or the like.

The display unit 740 may be a device which displays the configuration of the GUI screen illustrated in FIGS. 2 to 6.

The communication unit 750 may access the communication network 50 illustrated in FIG. 1 and may be a communication module which is configured to access various communication networks such as a personal area network (PAN), a local area network (LAN), a metropolitan area network (MAN), a wide area network (WAN), an Internet network, a mobile communication network, and a heterogeneous communication network configured by a combination thereof.

The system bus 770 may connect the above-described elements 710 to 750 so as to communicate with one another.

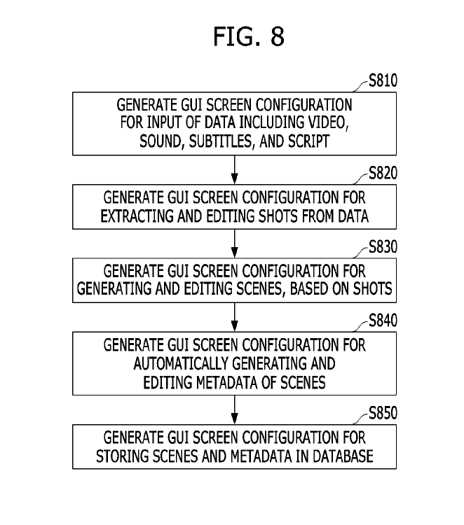

FIG. 8 is a flowchart of a method of providing a GUI screen for authorizing video scene and metadata according to an embodiment of the present invention.

Referring to FIG. 8, first, in step S810, a process of generating a GUI screen configuration for an input of data including a video, sound, subtitles, and a script may be performed by the computer processor. The process may include a process of generating a progress state block which displays an operation progress situation, a process of generating a first information output window which displays information about the data, a process of generating a data input block through which the information about the data is input, and a process of generating a second information output window which displays a video scene and introduction information about a metadata authorizing tool.

Subsequently, in step S820, a process of generating a GUI screen configuration for extracting and editing shots from the data may be performed by the computer processor. The process may include a process of generating a progress state block which displays an operation progress situation, a process of generating a shot extraction result output window which displays shot extraction result information generated while the shots are being extracted, a process of generating a shot information output window which displays information about the extracted shots, a process of generating a connection bar block which displays correlation between the extracted shots, and a process of generating an image window which displays representative key frame images of the extracted shots. Here, at least one representative key frame image selected from among the representative key frame images of the extracted shots may be deleted, and for example, may be deleted by using a drag and drop function.

Subsequently, in step S830, a process of generating a GUI screen configuration for generating and editing scenes based on the shots may be performed by the computer processor. The process may include a process of generating a progress state block which displays an operation progress situation, a process of generating a scene generation result output window which displays result information generated while the scenes are being generated, a process of generating a scene information output window which displays information about the generated scenes, a process of generating a connection bar block which displays correlation between the generated scenes, and a process of generating an image window which displays representative key frame images of the generated scenes.

Subsequently, in step S840, a process of generating a GUI screen configuration for automatically generating and editing metadata based on the scenes may be performed by the computer processor. The process may include a process of generating a progress state block which displays an operation progress situation, a process of generating a scene information output window which displays information about a scene corresponding to metadata which is being generated, a process of generating a metadata generation result output window which displays metadata generation result information generated while the metadata is being generated, a process of generating an image window which displays a representative key frame image of the scene corresponding to the metadata which is being generated, and a process of generating a connection bar block which displays correlation between scenes by using a connection bar. Here, the metadata generation result output window may display the metadata generation result information as a table, and the table may be table type information which includes a headword associated with a corresponding scene and similarity between the corresponding scene and the headword. Also, the metadata generation result output window may display the metadata generation result information by using headwords associated with a corresponding scene, and the headwords may be displayed to have different text sizes and colors, based on correlation with the corresponding scene.

Subsequently, in step S850, a process of generating a GUI screen configuration for storing the scenes and the metadata in a database may be performed by the computer processor. The process may include a process of generating a progress state block which displays an operation progress situation, a process of generating a scene information output window which displays information about the scenes while the generated and edited scenes and the generated and edited metadata are being stored in the database, and a process of generating a state information output window which displays a graphic object enabling a user to visually recognize a progress situation where the generated and edited scenes and the generated and edited metadata are stored in the database.

According to the embodiments of the present invention, a process of extracting and generating a shot, a scene, and metadata from a video may be automatized, a shot extracting operation, a scene generating operation, and a metadata generating operation may be manually controlled, and automatically generated shot, scene, and metadata may be corrected and edited.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of authorizing a video scene and metadata for providing a graphical user interface (GUI) screen provided to a user for authorizing the video scene and the metadata in an electronic device including a computer processor, the method comprising:
(A) generating, by the computer processor, a GUI screen configuration for an input of data including a video, sound, subtitles, and a script;
(B) generating, by the computer processor, a GUI screen configuration for extracting and editing shots from the data;
(C) generating, by the computer processor, a GUI screen configuration for generating and editing scenes, based on the shots;
(D) generating, by the computer processor, a GUI screen configuration for automatically generating and editing metadata of the scenes; and
(E) generating, by the computer processor, a GUI screen configuration for storing the scenes and the metadata in a database.

2. The method of claim 1, wherein in step (A), the generating of the GUI screen configuration comprises:
generating a progress state block which displays an operation progress situation;
generating a first information output window which displays information about the data;
generating a data input block through which the information about the data is input; and
generating a second information output window which displays introduction information about a metadata authorizing tool and the video scene.

3. The method of claim 1, wherein in step (B), the generating of the GUI screen configuration comprises:
generating a progress state block which displays an operation progress situation;
generating a shot extraction result output window which displays shot extraction result information generated while the shots are being extracted;
generating a shot information output window which displays information about the extracted shots;
generating a connection bar block which displays correlation between the extracted shots; and
generating an image window which displays representative key frame images of the extracted shots.

4. The method of claim 3, further comprising: deleting at least one representative key frame image selected from among the representative key frame images of the extracted shots,
wherein the at least one representative key frame image is deleted by using a drag and drop function.

5. The method of claim 1, wherein in step (C), the generating of the GUI screen configuration comprises:
generating a progress state block which displays an operation progress situation;
generating a scene generation result output window which displays result information generated while the scenes are being generated;
generating a scene information output window which displays information about the generated scenes;
generating a connection bar block which displays correlation between the generated scenes; and
generating an image window which displays representative key frame images of the generated scenes.

6. The method of claim 5, further comprising: deleting at least one representative key frame image selected from among the representative key frame images of the extracted shots,
wherein the at least one representative key frame image is deleted by using a drag and drop function.

7. The method of claim 1, wherein in step (D), the generating of the GUI screen configuration comprises:
generating a progress state block which displays an operation progress situation;
generating a scene information output window which displays information about a scene corresponding to metadata which is being generated;
generating a metadata generation result output window which displays metadata generation result information generated while the metadata is being generated;
generating an image window which displays a representative key frame image of the scene corresponding to the metadata which is being generated; and
generating a connection bar block which displays correlation between scenes by using a connection bar.

8. The method of claim 7, wherein
the metadata generation result output window displays the metadata generation result information as a table, and
the table is table type information which includes a headword associated with a corresponding scene and similarity between the corresponding scene and the headword.

9. The method of claim 7, wherein
the metadata generation result output window displays the metadata generation result information by using headwords associated with a corresponding scene, and
the headwords are displayed to have different text sizes and colors, based on correlation with the corresponding scene.

10. The method of claim 1, wherein in step (E), the generating of the GUI screen configuration comprises:
generating a progress state block which displays an operation progress situation;
generating a scene information output window which displays information about the scenes while the generated and edited scenes and the generated and edited metadata are being stored in the database; and
generating a state information output window which displays a graphic object enabling a user to visually recognize a progress situation where the generated and edited scenes and the generated and edited metadata are stored in the database.
